(19) United States
(12) Patent Application Publication
(10) Pub. No.: US 2002/0030707 A1
(43) Pub. Date: Mar. 14, 2002

(54) Modular dampening system spray bar having individual, localized control spray nozzles

(76) Inventors: Peter K. Arnold JR., Olathe, KS (US); Jessica L. Brunk, Edgerton, KS (US); Kenneth A. Leavell, Shawnee, KS (US); Dennis D. Schupp, Leawood, KS (US); David Michael Strumpf, Columbia, MO (US)

Correspondence Address: HOVEY WILLIAMS TIMMONS & COLLINS, 2405 GRAND BLVD., SUITE 400, KANSAS CITY, MO, 64108

(21) Appl. No.: 09/946,208

(22) Filed: Sep. 5, 2001

Related U.S. Application Data
(63) Continuation of application No. 09/416,455, filed on Oct. 12, 1999.

(51) Int. Cl. B41J 29/38

(52) U.S. Cl. 347/9

(57) ABSTRACT

A spray bar dampening system (10) having at least one spray bar (12) that is controlled with a distributed control system to provide high-speed adaptive and custom control of spray dampening in a printing press or other application. Along with the spray bar, the dampening system includes a bar address module (14) for coupling with the spray bar, a speed converter module (16), a network interface module (18), and a remote terminal module (20) that all communicate with one another over a communications bus (22). Each module performs distributed control functions unique to its particular place in the overall system. The spray bar includes an elongated support (24); a plurality of spray nozzles (26) spaced along the support; a conduit (28) carried by the support and connected to the nozzles for supplying fluid or other substance thereto; a plurality of electrically actuated valves (30) operable to control the flow of fluid or other substance through the conduit to the nozzles; a plurality of valve drive elements (32) for driving the valves; a bar interface module (38) positioned on the support and operable for receiving information from an external control element and for calculating a spray request signal such as a target pulses per minute (PPM) valve in response to the information; and a plurality of valve control modules (40) positioned on the support, each coupled between the bar interface module and one of the valve drive elements, for controlling operation of the valve drive element in response to the spray request from the bar interface module.

### RELATED APPLICATION

This is a continuation of application Ser. No. 09/416,544 filed Oct. 12, 1999.

### BACKGROUND OF THE INVENTION

1. Field of the Invention

The present invention relates to spray bar dampening systems operable for spraying fluids or other substances onto printing press rollers or other devices. More particularly, the invention relates to a spray bar dampening system including a spray bar operable for spraying high-speed modulation controlled spray pulses of fluid at varying pulse rates that provide continuous flow control and includes a distributed control system for controlling operation thereof.

1. Description of the Prior Art

The printing plate of an offset lithographic press typically has etched, image areas for reception of an ink solution. The remaining, unetched portions of the plate comprise the nonimage areas that are commonly supplied with dampening fluid in order to resist the deposition of ink in these areas. High quality printing can be obtained only when the correct ink/dampening fluid balance is maintained. The ideal ratio of ink to dampening fluid is a function of the type of plate, the number of image areas on the plate, the composition of the paper and also the chemistry of the dampening solution.

Failure to maintain the correct ink/dampening fluid balance in a printing press can lead to disastrous results. For example, excessive emulsification of ink may occur when an oversupply of water flows to the plate, diluting the strength of the ink and causing the printed image to lack sharp contrast. Excessive emulsification also often causes the ink to rub off the paper and onto the reader's hands. It is sometimes necessary to stop a press once such excessive emulsification is observed so that the ink train may be completely cleaned before a large quantity of printed copy is adversely affected.

Spray dampening systems have been developed for delivering the aforementioned dampening fluid in a controlled manner to printing plates. Spray dampening systems typically include a number of spray bars each having a plurality of spray nozzles spaced along the length thereof and valves that are repetitively opened and closed to direct a pulsed stream of fluid through the nozzles toward a dampening roller associated with the plate cylinder. The amount of water sprayed toward the dampening roller is automatically varied in accordance with the speed of the press.

The spray characteristics of spray bars typically change over time due to nozzle clogging, mechanical wear, age, and other factors. Thus, spray bars must be periodically replaced with new spray bars. This is a problem with prior art spray bar technology because every spray bar has unique spraying characteristics, necessitating individual field-calibrating of each spray bar as it is installed to ensure the optimal delivery of spray dampening fluid. Those skilled in the art will appreciate that field calibrating of spray bars is difficult and time-consuming and therefore results in excessive printing press down time.

Another limitation of prior art spray bars is that all of their valves are typically wired to a single centralized controller that controls the operation thereof. Such central control of spray bars is disadvantageous for two primary reasons. First, if a spray bar needs to be exchanged for a new spray bar, the new spray bar will likely not have the same spray characteristics as the old bar and will need to be recalibrated as described above. Prior art central controllers are not capable of providing such recalibration; therefore, the entire printing press must be stopped while a new spray bar is manually calibrated during installation.

The other problem associated with central spray bar controllers is that the central controller merely provides “generic” instructions to each of the nozzles of the spray bars without taking into account unique spray characteristics of each spray bar. Moreover, central controllers merely provide instructions to the spray bars but do not receive feedback information from the spray bar that may be useful in adjusting spray characteristics.

Accordingly, there is a need for an improved spray bar dampening system that overcomes the limitations of the prior art. More particularly, there is a need for a spray bar that can be calibrated during manufacture and then substituted for a worn spray bar without the need for extensive field calibration. There is also a need for a spray bar dampening system having a distributed control scheme that applies control sequences at the appropriate level within the system and that receives feedback information to adjust the operation thereof.

### SUMMARY OF THE INVENTION

The present invention solves the above-described problems and provides a distinct advance in the art of spray bars for use in printing presses and other applications. More particularly, the present invention provides a spray bar design that allows a spray bar to be substituted for an existing spray bar that is to be replaced without requiring excessive field calibration. The present invention also provides a spray bar dampening system having a plurality of spray bars that are controlled with a distributed control system to provide high-speed adaptive and custom control of spray dampening for each spray nozzle on each spray bar.

The spray dampening system of the present invention includes several modules that each apply control at a selected control level. Each module is only responsible for its particular control functions and communicates with other modules for receiving instructions therefrom and transmitting instructions thereto. Therefore, each module can perform its control functions in such a way as to take into account information and variables unique to its particular control level without the need to process information unrelated to its control level. The modular architecture of the system allows an installation architect to create an installation for each printing press or other application that is tailored to fit the needs of each site. This concept allows manufacturers of the dampening system to maintain standard inventory of minimal module types that serve functions as needed for their customers.

The spray bar dampening system of the present invention broadly includes at least one spray bar, a bar address module for coupling with its spray bar, a speed converter module, a network interface module, and a remote terminal module that all communicate with one another over a communications bus.

The preferred spray bar broadly includes an elongated support; a plurality of spray nozzles spaced along the length of the support; a conduit carried by the support and connected to the nozzles for supplying dampening fluid or other substance thereto; a plurality of electrically actuated valves operable to control the flow of fluid through the conduit to the nozzles; a plurality of valve drive elements for driving the valves; a bar interface module positioned on the support and operable for receiving information from an external control element and for calculating a spray request signal such as a target pulses per minute (PPM) valve in response to the information; and a plurality of valve control modules positioned on the support, each coupled between the bar interface module and one of the valve drive elements, for controlling operation of the valve drive elements in response to the spray request from the bar interface module.

Each valve control module includes drive circuitry for directing its corresponding valve drive element to open and close its corresponding valve in response to the spray request in accordance with pre-calibrated on and off duty cycles. Each valve control module also includes a feedback circuit coupled between its valve drive element and its drive circuitry for monitoring operation of the valve drive element and for generating corresponding feedback signals that may be used to alter the control of the valve drive element.

These and other important aspects of the present invention are described more fully in the detailed description below.

### BRIEF DESCRIPTION OF THE DRAWING FIGURES

A preferred embodiment of the present invention is described in detail below with reference to the attached drawing figures, wherein:

FIG. 1 is a partially schematic elevational view of a spray bar constructed in accordance with a preferred embodiment of the present invention illustrating a fluid spray pattern onto a printing press roller;

FIG. 2 is a fragmentary plan view of the spray bar with the cover thereof shown in section;

FIG. 3 is a fragmentary vertical sectional view of the spray bar;

FIG. 4 is a vertical sectional view of the spray bar taken along 4-4 of FIG. 3;

FIG. 5 is a schematic view of the components of a spray bar dampening system constructed in accordance with a preferred embodiment of the present invention;

FIG. 6 is a block diagram illustrating the components of the bar interface module of the spray bar;

FIG. 7 is a block diagram illustrating the components of the valve control module of the spray bar; and

FIG. 8 is a graph of several signals related to operation of the valve control module.

### DETAILED DESCRIPTION OF THE PREFERRED EMBODIMENTS

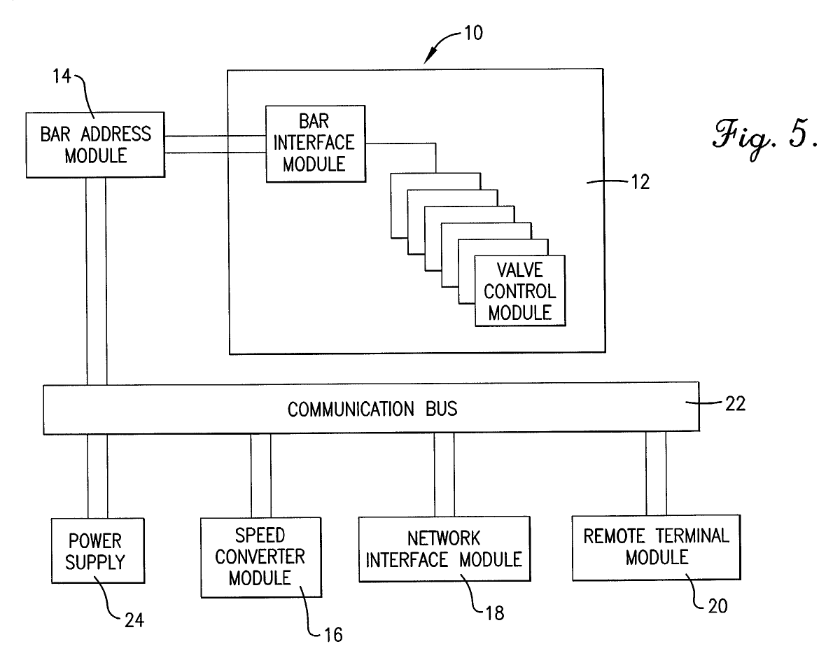

Turning now to the drawing figures, and particularly FIG. 5, a spray bar dampening system constructed in accordance with a preferred embodiment of the present invention is illustrated. The dampening system broadly includes at least one spray bar 12, a bar address module 14 for each spray bar, a speed converter module 16, a network interface module 18, and a remote terminal module 20 that all communicate with one another over a communications bus 22. Each module is capable of two-way communication with the other modules in a master/slave configuration by issuing and receiving ASCII commands and instructions. The modules of the spray dampening system are powered by a conventional power supply 24, which preferably provides an adjustable 24-36 volt DC output for delivery to the modules over the communication bus. Each of the components of the dampening system is described in detail below.

### Spray Bar

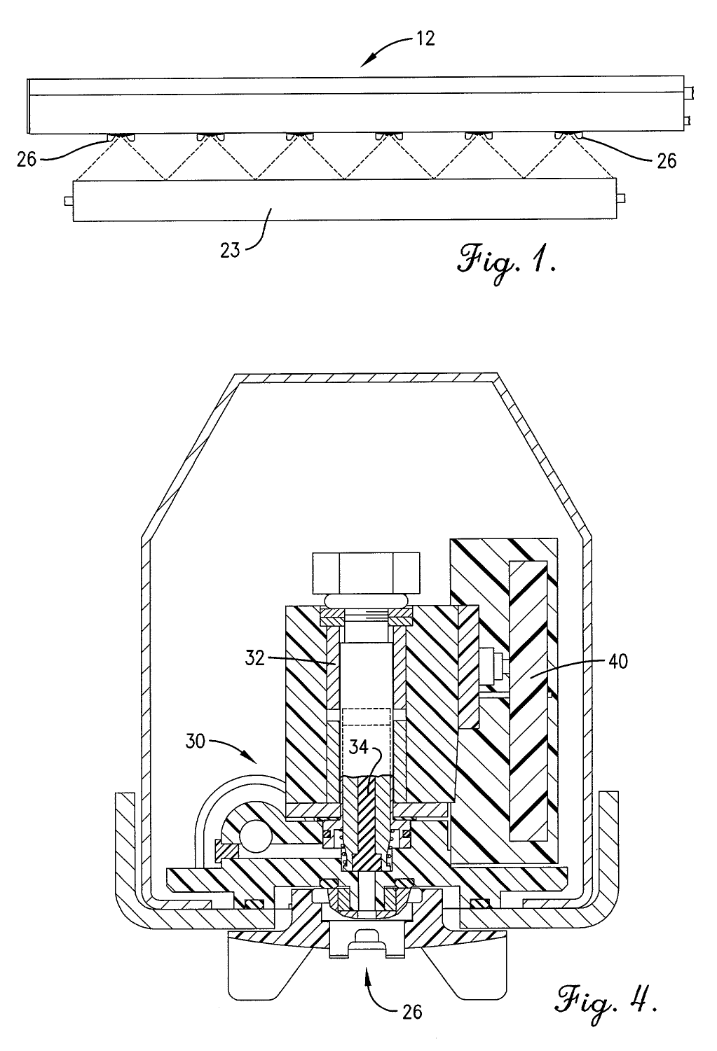

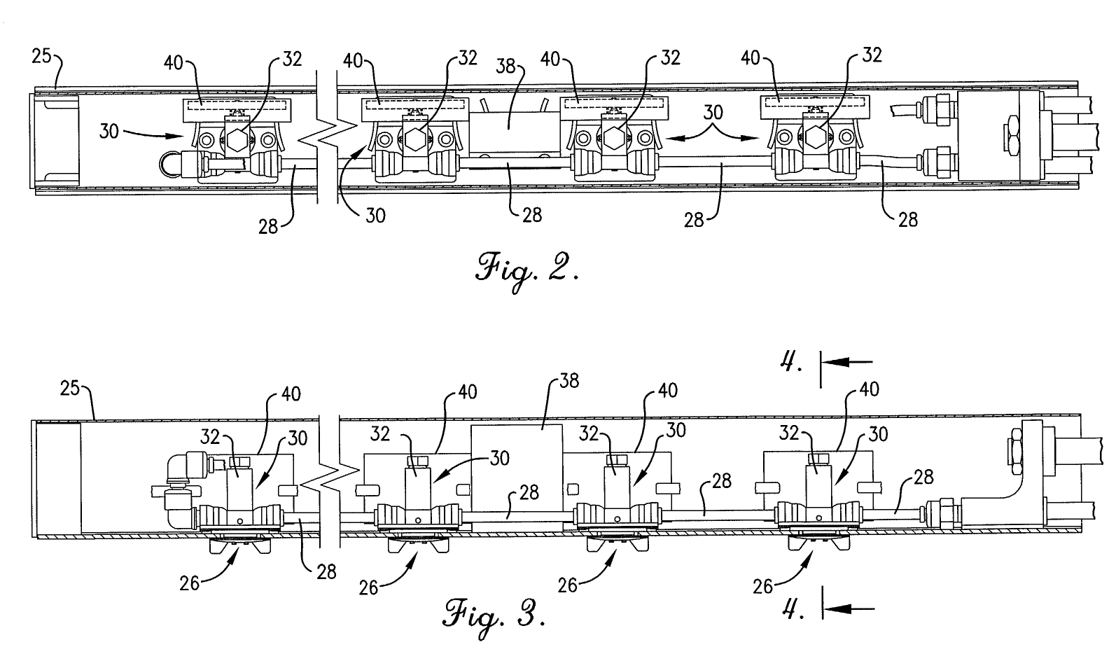

The spray bar 12 is operable for spraying a dampening fluid or other substance onto a printing press roller 23 or other component as depicted in FIG. 1. As best illustrated in FIGS. 2, 3, and 4, the spray bar broadly includes an elongated support 25, a plurality of spray nozzles 26 spaced along the support, a series of conduits 28 carried by the support and connected to the nozzles for supplying dampening fluid or other substances thereto, a plurality of electrically actuated valves 30 interposed between the conduit and the spray nozzles to control the flow of fluid or other substances through the conduit to the nozzles, and a plurality of valve drive elements 32 for driving the valves. The aforementioned components of the spray bar are entirely conventional and are described in U.S. Pat. No. 4,708,058, hereby incorporated into the present application by reference.

In more detail, the conduits 28 receive dampening fluid from an inlet and then deliver the fluid to the valves 30 in a serial fashion. The last valve in the serial line of valves returns the dampening fluid to a return conduit line for return to the source of the dampening fluid.

As best illustrated in FIG. 4, the valves 30 are preferably solenoid or servo type valves each including a reciprocal plunger 34 or other valve flow controller moveable by its valve drive element 32. As is well known in the art, when the plunger reciprocates up under the direction of the valve drive element, pressurized dampening fluid present in the supply line passes under the valve plunger and out the nozzle. Conversely, when the plunger is shifted downward by the valve drive element, the plunger interrupts the flow of dampening fluid from the supply line. The valve drive elements 32 are preferably solenoid type operators but may also be voice coil, piezo, polymer activated, or servo type drive elements.

In accordance with one important aspect of the present invention, each spray bar 12 also includes a spray bar control system for controlling operation thereof at a local level. The spray bar control system broadly includes a single bar interface module 38 and a plurality of valve control modules 40 all positioned on the elongated support of the spray bar.

The spray bar control system is capable of providing independent, adaptive and dynamic controls that respond to a printing press' operation. All logical decisions during a press run are made within the spray bars 12 and will continue to operate even without network communication.

The spray bar control system controls operation of its spray bar 12 so as to deliver highspeed “modulation controlled” spray pulses of fluid varying fluid pulse rates in such a way as to maintain an average spray volume while integrating a spray pulse pattern over time to yield consistent planar spraying patterns that meet predetermined specifications. The fluid spray pulse duration is controlled to yield a constant and is a result of dynamically controlling electrical control signals to yield a consistent amount of water volume per pulse and uniform conical dispersion pattern onto the printing press roller or other device.

Those skilled in the art will appreciate that printing press rollers require varying amounts of water or other fluid as the speed of a printing press changes. The dampening system 10 of the present invention is controlled so as to accommodate a varying need for water volume over time by changing pulse rates on each individual valve 30 and all the spray bars 12 in the system. Each valve on each spray bar is pulsed at a rate that is proportional to the speed of the printing press that its corresponding roller is attached. By adjusting the fluid pulse rate of the valve and maintaining a consistently constant spray pulse time, a spray bar maintains even flow to its roller at all press speeds.

### Bar Interface Module

The bar interface module 38 is operably coupled between the communication bus 22 and all of the valve control modules 40 on its spray bar 12 as depicted in FIG. 5. The bar interface module is operable for receiving information from other control modules as described below and for calculating a spray rate request signal for each valve on its spray bar in response to the information. The bar interface module delivers these spray rate requests to the valve control modules on its spray bar, which in turn control operation of their respective valve control elements to comply with the spray rate request.

For example, the bar interface module 38 receives press speed information from the speed converter module 16 and calculates a PPM request value (REQ PPM) to be delivered to the valve control modules 40 on its spray bar 12. The bar interface module calculates the REQ PPM value 20 times per second by monitoring the frequency signals (FRQBUS) which are driven by the speed converter module. FRQBUS provides a linear curve signal from 1-1000 Hz that corresponds to 0% to 100% of press operating speed. This frequency is monitored by the bar interface module and input into a dynamic adaptive flow algorithm resident in the bar interface module that calculates the optimal REQ PPM at the current moment in time. This concept allows each bar interface module to monitor a unique FRQBUS signal independent of other bar interface modules.

The bar interface module 38 also monitors a signal indicating that the printing press has begun to print (FORMS CONTACT). The bar interface module responds to a FORMS CONTACT signal by addressing each of the valve control modules 40 on its spray bar 12 and instructing the valve control modules to begin spraying.

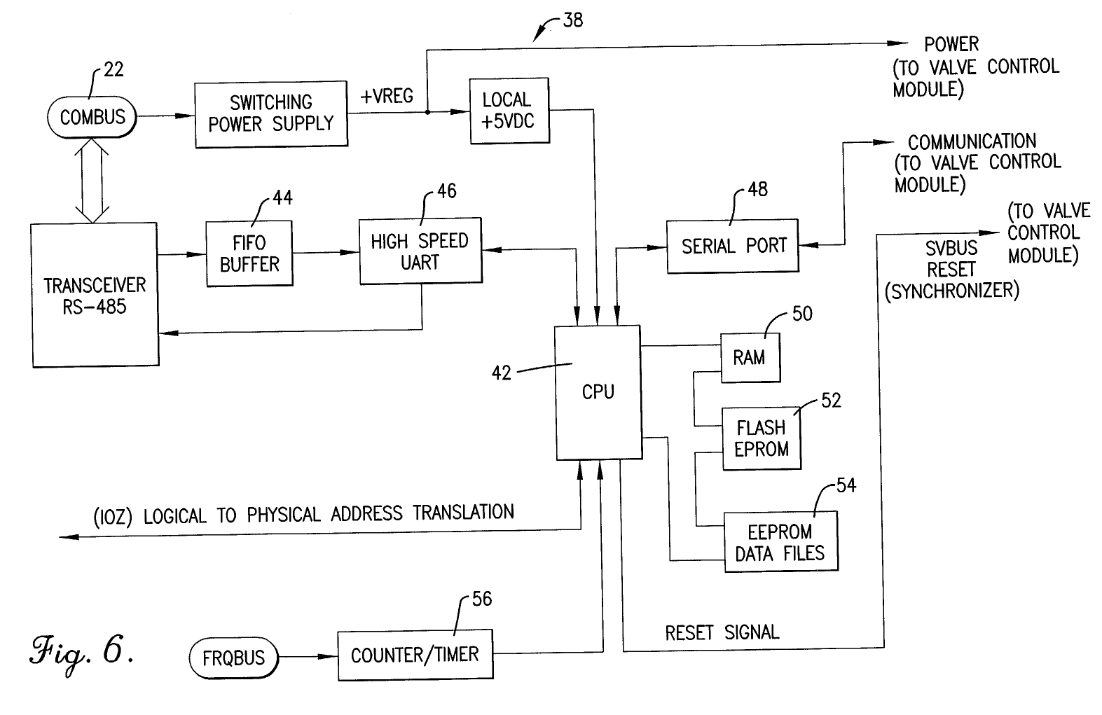

A bar interface module 38 constructed in accordance with a preferred embodiment of the present invention is illustrated in FIG. 6 and includes a CPU 42 such as a microcontroller. The CPU runs the dynamic adaptive flow algorithm and is operable for receiving the FRQ BUS signal from the speed converter module 16 and for calculating the target PPM value. The CPU also receives an IOZ signal (logical to physical address translation) from the bar address module 14 that allows the bar interface module to self-locate itself within the overall dampening system 10 as described in more detail below. This permits a system operator to make all references to spray bars by physical location instead of cumbersome logical bar interface module addresses.

The bar interface module 38 also includes a first in/first out (FIFO) buffer 44, a primary high-speed universal asynchronous receiver transmitter (UART) 46, and a secondary serial port 48 all coupled with the CPU 42. The FIFO buffer and primary high-speed UART allow the bar interface module to negotiate high speed data traffic on the COMBUS. The secondary serial port passes communication signals between the bar interface module and the valve control modules on its spray bar.

The preferred bar interface module 38 also includes random access memory (RAM) 50 coupled with the CPU 42 and used by the CPU to rapidly access variable and constantlychanging data for control algorithms described below; an electrically alterable programmable memory (flash EPROM) 52 for storing communication protocols and control algorithms such as the dynamic adaptive flow algorithm; and an electrically erasable read-only memory (EEPROM) data files 54 for storing certain calibration values described below. Finally, the bar interface module also includes a counter/timer 56 for counting the FRQ BUS signal from the speed converter 16. The components of the bar interface module are preferably positioned on a small potted circuit board 56 that is attached to the spray bar support. The circuit board is potted with material so that it is waterproof, corrosion proof, and chemical resistant.

### Valve Control Modules

Each valve control module 40 is operably coupled between the bar interface module 38 on its spray bar and one valve drive element 32 and is responsible for responding to commands issued by the bar interface module and executing valve control actions for its valve drive element based on the high-level commands received. The valve control modules evaluate all commands received to determine whether it is possible to perform the requested function. The valve control modules control only valve related functions and do not monitor other parameters such as press speed. The bar interface module has the responsibility to monitor press speed as described above and relays the information periodically to the valve control modules within its spray bar. The valve control modules on the spray bar are attached together in a serial or daisy-chain configuration. A terminator is placed on the last valve control module to indicate the end of the daisy chain.

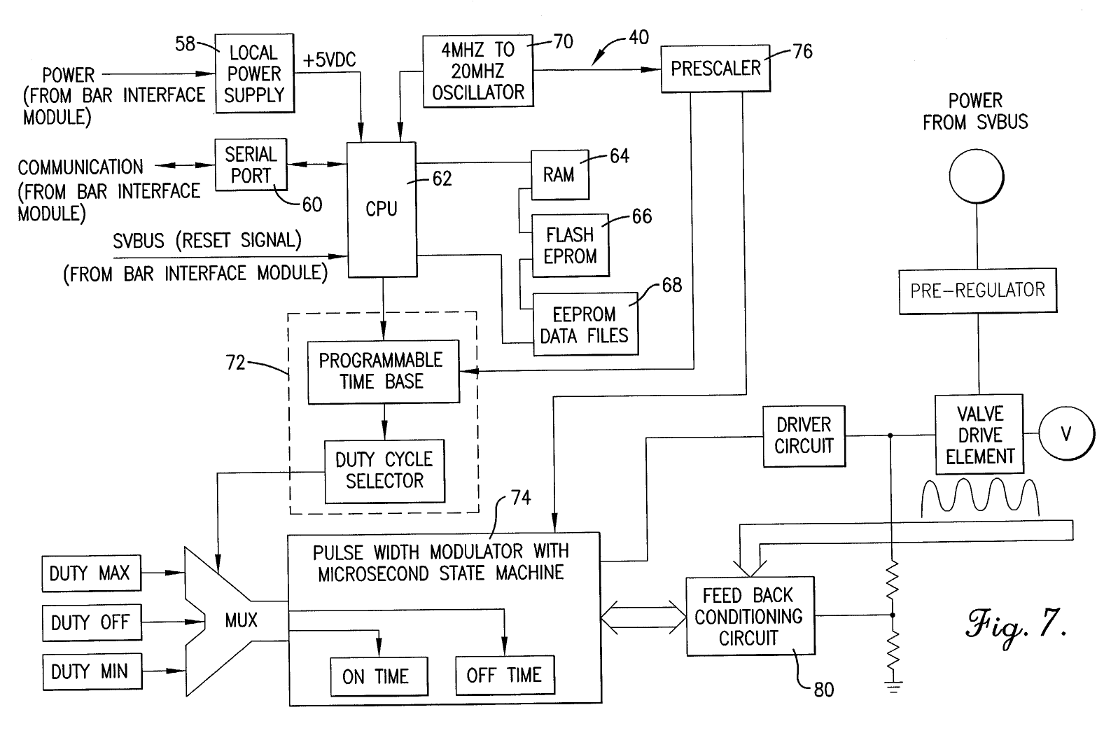

As illustrated in FIG. 7, each valve control module 40 includes a local power supply 58, a serial port 60, a CPU 62, RAM 64, flash EPROM 66, EEPROM data files 68, an oscillator 70, state machine firmware 72 resident or accessible by the CPU, a pulse width modulator (PWM) 74, a programmable frequency divider (prescaler) 76, and a feedback conditioning circuit 80. These components are preferably positioned on a small potted circuit board that may be attached directly to its corresponding valve drive element 32 as illustrated in FIG. 4. The circuit board is potted with material so that it is waterproof, corrosion proof, and chemical resistant.

The local power supply 58 is responsible for providing “clean” power for the low voltage sections of the valve control module 40. The serial port 60 (or UART) is a bidirectional communication module capable of routing command packets that are initiated by the bar interface module.

The CPU 62 is the local processing element that executes the state machine firmware 72 that is resident in the valve control module. The CPU may be a microcontroller or any other computing device. The RAM 64 is used by the CPU to rapidly access the variable and constantly changing data for control algorithms. The flash EPROM 66 contains the communication protocols and control algorithms for the valve control module valve control. The EEPROM data files 68 are non-volatile storage cells responsible for maintaining the calibration values discussed above. The oscillator 70 is used to drive the CPU timing, to generate timing signals for the state machine firmware and drive the PWM. The prescaler 76 is used to create the desired output signals for the state machine Firmware and the PWM element.

The state machine firmware 72 consists of a programmable timebase 82 and a duty cycle selector 84. The programmable timebase is essentially a 2nd stage divider driven by the 1 MHZ signal provided by the prescaler 76. The timebase is used to initiate a CPU interrupt that executes the state machine logic to a timing resolution of 1 microsecond. The state machine's job is to determine the proper adjustments to DUTY MIN, DUTY MAX, and DUTY OFF values described below along with tracking the desired on time and off time modulation variables discussed below.

The state machine is applied in the system in order to provide consistent responsiveness to valve control that provides timing resolution of One (1) microsecond. This means that the operator can define curve data that yields calculated on-time and off-times with 6 decimal places of precision.

Although the valve control module is extremely efficient in responding to state machine timing requests, the overall accuracy of the system is reduced to 5 decimal places even though the resolution is maintained at 6 decimal places. This is due to the method of CPU interrupt processing used. The CPU is constructed with Reduced Instruction Set Computing (RISC) technology. This means that every instruction performed by the CPU is simple and efficient. A side benefit of RISC architecture is that each instruction only takes one clock cycle to execute. The advantage to the state machine is that the time delay to process a state-machine interrupt (referred to as “interrupt latency”) is very short. Although the interrupt latency is very short, it is variable. This variance can be +/− two to three instructions which can yield a worst case variance of +/− five (5) microseconds. For this reason, we must specify the true accuracy in 10's of microseconds for the overall system while maintaining a true resolution of 1 microsecond. Interrupt latency can be decreased by simply operating the CPU at high speeds.

Once the state machine logic 72 has executed its interrupt tasks, it updates the programmable timebase 82 with the precise time of the current pulse (on or off pulse). After updating the timebase value in microseconds, the interrupt is complete and the foreground performs periodic checks (20 times per second) to see if a request for PPM calculations has been made by the bar interface module. If a request has been made by the bar interface module 38, then the dynamic adaptive flow algorithm recalculates the most practical on time and off time values based on the current settings within the valve control module 40. This is typically determined by the bar interface module forcing a new on time value and then requesting a new PPM value. Other priorities can be performed and the valve control module will respond to the order in which the request are made. (i.e. If an operator wants to override the PPM by requesting on time and off time directly, the valve control module would obey the commands accordingly).

Energy requirements to displace a servo valve plunger vary over time. For example, when a servo valve is first turned on, it must overcome initial friction and spring forces. Then, once the valve is open (or reaches a stable modulation rate), less energy is required to hold it open (or perform the work for the remaining time of the spray pulse). Prior art analog type servo valve control mechanisms merely provide the same amount of energy to a servo valve during its entire open cycle even after initial friction and spring forces have been overcome. This often results in premature “burnout” of the coils of a servo valve, necessitating premature replacement of the valves. Excessive heat also reduces the performance of the mechanical components due to physical expansion.

To avoid such premature wear and to conserve energy, the valve control modules 40 of the present invention use a combination of energy transfer values including a DUTY_MAX value, a DUTY_MIN value and a DUTY_OFF value that are automatically routed to their respective PWMs 74 by their state machines 72. The DUTY_MAX is a value that his significant instantaneous energy that is needed for initial movement while the DUTY_MIN value has much less energy transfer (due to a lower proportional PWM value) which yields more efficient energy use and less heat generated. The DUTY_OFF value has an even lower energy level that is only slightly above 0 that is used to more finely control a servo valve when it is turned off. DUTY_OFF adjustments also allow modulation of a valve that yields continuous fluid flow at variable flow rates without discrete on and off fluid spray periods. By using these techniques, each valve control module can provide efficient control of its valve and avoid increased friction due to overheating.

In more detail, each valve control module 40 uses a precise timing system consisting of timebase divisor values that allow a timing resolution of 1 microsecond. These timebase divisors are stored in the following variables:

DUTY_MAX=The maximum desirable transfer of effective energy to a valve drive element during modulation for a specific calibrated valve sample. (0-100%) [Used during initial 1 msec of on time].

DUTY_MIN=The minimum desirable transfer of effective energy to a valve drive element during modulation for a specific calibrated valve sample. (0-100%) [Used during on time immediately after DUTY_MAX].

DUTY_OFF =The minimum desirable transfer of effective energy to a valve drive element during modulation for a specific calibrated valve sample. (0-100%) [Used during off time].

ON_TQM=The gross scaling of on time in milliseconds (On time queue millisecond integer component).

ON_TQD=The fine scaling of on time in microseconds (On time queue millisecond decimal component).

NULL_TIME=The non-working portion (before flow begins) of on time.

MS _ON=(ON_TQM*1000)+ON_TQD+NULL_TIME (in μsec).

During the MS_ON portion of the waveform, the DUTY_MIN value is used as the nominal parameter by the PWM module. The PWM 74 can then adjust itself, based on the feedback provided by the feedback conditioning circuit around the center setting of DUTY-MIN and cancel errors in the effective energy transfer to the valve drive element.

OFF-TQM=The gross of off time in milliseconds (Off time queue millisecond integer component).

OFF_TQD=The fine scaling of off time in microseconds (Off time queue millisecond decimal component.

MS_OFF =(OFF_TQM*1000)+OFF_TQD (in μsec).

During the MS_OFF portion of the waveform, the DUTY_OFF value is used as the normal parameter by the PWM 74. The PWM module can then adust itself, based on feedback, around the center setting of DUTY_OFF and cancel errors in the effective energy transfer to the valve drive element.

Each valve control module 40 is calibrated at the factory to determine the optimal settings for NULL_TIME, DUTY_MIN, DUTY_MAX and DUTY_OFF. These values become the nominal values for each specific valve control module and each valve control module may have very different values based on mechanical variances. The valve control module's adaptive algorithms are responsible to carry out requested commands with the knowledge and awareness of its own capabilities and limitations as a valve controller.

By using a combination of high frequency PWM and adaptive algorithms at one microsecond resolution, energy transfer to the valve drive elements is extremely predictable within each system configuration. Furthermore, each valve control module 40 is programmable to allow fine calibration to store differences in energy transfer values in non-volatile memory. This means that two identical valve control modules can provide different waveforms as needed without any other part of the system being burdened by the inconsistencies of mechanical variances.

Another benefit of this concept over other drive systems is that all of the precise movement accomplished by the valve control modules 40 is generated entirely by high frequency digital signals. Almost no heat is generated, no bulky components are required, yet analog movement that translates into linear displacement of a valve is obtained.

### Spray Bar Operation

During operation of a spray bar 12, the spray bar's bar interface module 38 receives frequency information relating to the press speed from the speed converter 16 as described above. The bar interface module determines whether the press is accelerating or decelerating and, based upon this decision, selects a target PPM value for the spray bar based upon the press speed from either an acceleration curve or deceleration curve accessible by a curve-tracking algorithm resident in the bar interface module CPU.

The bar interface module 38 then transfers this PPM request to each of the valve control modules 40 so that the value control modules may control operation of their respective valves for achieving the requested PPM. When a valve control module receives a command requesting a new REQ PPM, it first determines how to adjust the offtime and/or ontime of its valve in order to provide the requested PPM. The CPU 62 of the valve control module, along with the duty cycle selector 84 of the state machine logic 72, then instruct the PPM 74 to route either a DUTY_MAX, DUTY_MIN, or DUTY_OFF signal to the PPM modulator. After the DUTY_MIN and DUTY_MAX signal (that is currently selected by the “duty cycle” selector) has been routed to the PWM modulator, the PWM begins to modulate (or rapidly turn on and off at a proportional on/off ratio equal to DUTY_MIN or DUTY_MAX) a signal on and off providing an output that integrates over time (or averages) into a signal of energy transfer. This energy transfer represents effective energy transfer to the valve drive element 32.

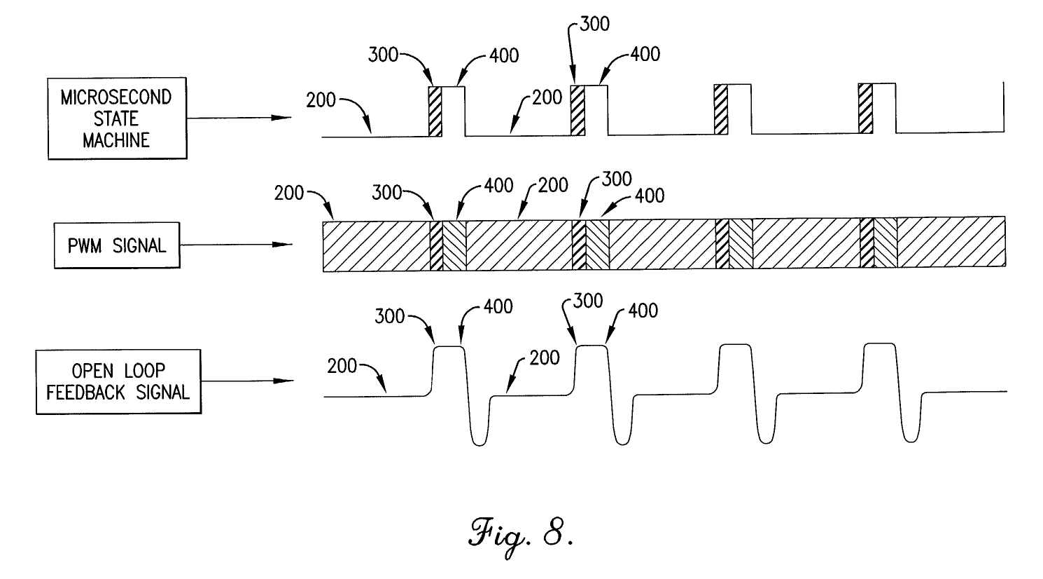

For example, a valve control module 40 may be pre-calibrated with a DUTY_MAX value of 85% of full power, a DUTY_MIN value of 15%, and a DUTY_OFF value of 5%. The PWM modulates the DUTY_MAX, DUTY_MIN, or DUTY_OFF signal that has been selected by the duty cycle selector 84 at a high rate of speed so as to obtain a PWM signal as shown in the second waveform of FIG. 8. Specifically, the PWM modulates the DUTY_MAX signal so that it is on 85% of the time and off 15% of the time to obtain an effective energy output of 85%, modulates the DUTY_MIN signal so that it is on 15% of the time and off 85% of the time to obtain an effective energy output of 15%, and modulates the DUTY_OFF signal so that it is on 5% of the time and off 95% of the time to obtain an effective energy output of 5%.

After the movement of the valve plunger or other flow controller begins, the feedback conditioning circuit 80 determines the work performed by the valve and sends a corresponding signal to the PWM element. The feedback conditioning circuit may provide either an open loop feedback signal or a closed loop feedback signal to the PWM.

The open loop feedback signal is an indirect feedback (or error resolver) technique that indirectly determines the result of the “work” performed. The open loop method uses a property of coil energy storage and kickback (or field collapse). The feedback signal represents a mirror image of the amplitude and shape of the energy delivered to the valve drive element, both in charge and discharge cycles that indicate the effectiveness of the work performed. With this information, the CPU 62 of the valve control module 40 can adjust the DUTY_MAX, MIN and OFF values to more effectively transfer energy to the valve. Ultimately, this process yields precision flow control without the need for expensive and bulky analog circuitry or sensors.

The closed loop feedback signal takes into account actual movement within the valve plunger by optical, magnetic, or mechanical feedback methods to monitor actual plunger movement. By monitoring plunger movement (and if desired, displacement), the state machine can gain precision beyond open loop by definite indication of work performed as opposed to indirect information.

The state machine logic 72 reviews the waveform of the feedback signal and determines any necessary adjustments to the PWM ratios which in turn change the effective energy output. This cycle rapidly repeats creating a self adapting correction mechanism for real world valve variance due to aging, temperature, pressure, etc.

In FIG. 8, the first waveform titled “Microsecond State Machine” shows the effective end result of energy transferred to a valve drive element. This is a composite of integrated (or averaged) energy seen by the valve drive element as usable power. The section of the graph marked with the numeral 200 indicates the DUTY_OFF value, the section marked with the numeral 300 indicates the DUTY_MAX value, and the section marked by the numeral 400 indicates the DUTY_MIN value.

The second waveform titled “PWM Signal” is a detail of the components within the previous waveform. The DUTY_OFF, DUTY_MAX, and DUTY_MIN values in this waveform are represented by the same numerals as the first waveform. The PWM signals provide on and off sourcing of power at a high rate of speed (50 KHZ to 250 KHZ) to modulate a lower (2-65000 msec) speed on time and off time. When viewed on an oscilloscope, the waveform can be viewed as the PWM signal. If the signal is viewed under operating conditions at the valve drive element, the top waveform will appear.

The third waveform titled “Open Loop Feedback Signal” shows the measurement of a feedback signal by the conditioning circuit. The DUTY_OFF, DUTY_MAX, and DUTY_MIN components of the feedback signal are referenced by the same numerals as the previous two waveforms.

### Bar Address Module

The bar address module 14 serves as a communication interface between the bar interface module 38 and the communications bus 22. The bar interface module is configured for mounting adjacent the spray bar 12, but is not part of the spray bar, and includes structure for electrically coupling with the bar interface module. The bar address module, along with the bar interface module 38, permit an operator to determine the physical location of any spray bar within an installation without knowing the logical address of a bar interface module.

For this purpose, the bar address module 14 contains a non-volatile memory chip that stores its physical address. The bar interface module 38 in turn stores a non-volatile code number that is preset at the factory or reprogrammed in the field that contains the logical network communication address for its respective spray bar. When a spray bar 12 is coupled with its bar address module 14, the bar address module and bar interface module communicate with one another so that the bar interface module can determine its physical location from the code stored in the bar address module.

By maintaining both physical and logical address codes that are always accessible on the network, an operator can use the remote terminal module described below to search and determine locations of any spray bar regardless of its physical placement in a building. This also allows an operator of the spray bar dampening system to create diagnostic maps and track potential problems by locating physical network packet failures and tracing their physical location. Other indirect system benefits are realized in tracking service and warranty records by maintaining a data file within the actual module that has been installed and/or repaired.

### Network Interface Module

The network interface 18 module attaches directly to the COMBUS 22 and is responsible for all data packet transfer on the COMBUS. The network interface module continually polls the bus for changes in status (or events that would require a change in status somewhere else on the bus. If an “event” is detected, the change of status is immediately processed and the resulting address(es) are alerted to the change. If no events are detected, the network interface module simply polls in a circular manner watching for events and monitoring for proper bus communication. The network interface may also include a modem or other communication device such as an ISDN, T1, or DSL interface for permitting remote control and monitoring of the printing presses to which it is attached.

### Remote Terminal Module

The remote terminal module 20 provides a user interface that permits an operator to monitor operations of the spray bars 12 in the dampening system 10 and to remotely control certain aspects of the spray bars. The remote terminal module is preferably operable to monitor and control operation of the spray bars of a plurality of different printing presses. Although the remote terminal module is normally provided for monitoring operations of the spray bars, it may also be used be used to issue commands to the spray bars that override the commands automatically calculated by the bar interface module of each spray bar.

The remote terminal module preferably includes a conventional display and keyboard. The display is preferably an LCD display having separate segments for displaying icons representative of the operation of the spray bar dampening system. The display may be a touch screen or membrane type display and may be of any preferred size. The keyboard is coupled with the display and the communication bus for permitting an operator to control the information that is displayed on the display and to provide control instructions to the communication bus for delivery to the other modules of the dampening system.

### Speed Converter Module

The speed converter module 16 is simply a network of solid state relays that are turned on one at a time to route the selected press speed signal (FRQBUS) to the bar interface module 38 of each spray bar 12. The FRQBUS contains frequency waveforms that are proportional in frequency to the speed of the printing press in real time. Numerous speed converters can be provided for the dampening system, but a bar interface module can only use one signal to control during a particular printing job.

### COM-BUS

The communications bus or COMBUS 22 is the system-wide communication network that provides communication between all of the described control modules. The system communication bus preferably includes six (6) wires that are run from point to point in a multi-drop configuration. The bus architecture can accommodate up to 128 modules on a single run. Each run requires two (2) termination resistors of 120 ohms resistance (one on each physical end) in order to electrically balance the bus signals.

### COM-BUS Signal Definition

1—Ground (Return signal for power and communication reference)

2—+BUSV (Adjustable +24-36 VDC Power)

3—COMA (RS485-A True/differential communication signal)

4—COMB (RS485-B Complement/differential communication signal)

5—FRQA (RS485-A True/differential press speed signal)

6—FRQB (RS485-B Complement/differential press speed signal)

The COMBUS is bidirectional and multi-master. This means that traffic can be initiated from many sources and responded from the receiver anywhere on the COMBUS.

Although the invention has been described with reference to the preferred embodiment illustrated in the attached drawing figures, it is noted that equivalents may be employed and substitutions made herein without departing from the scope of the invention as recited in the claims. For example, although the spray bar dampening system of the present invention has been illustrated and described as being particularly useful in a printing press application, it may also be used in other applications requiring controlled pulses of water or other fluid.

Having thus described the preferred embodiment of the invention, what is claimed as new and desired to be protected by Letters Patent includes the following:

1. A spray bar comprising:
an elongated support;
a plurality of spray nozzles spaced along the support;
a conduit carried by the support and connected to the nozzles for supplying fluid or other substance thereto;
a plurality of electrically actuated valves moveable proportionally between opened and closed positions to control the flow of fluid or other substance through the conduit to the nozzles;
a plurality of valve drive elements for driving the valves proportionally between the opened and closed positions;
a bar interface module positioned on the support and operable for receiving information from an external control element and for calculating a spray request signal in response to the information; and
a plurality of valve control modules positioned on the support, each coupled between the bar interface module and one of the valve drive elements, for controlling operation of the valve drive elements in response to the fluid spray rate request from the bar interface module.

2. The spray bar as set forth in claim 1, wherein the external control element is a speed measuring device for measuring speed of a printing press, the information being press speed.

3. The spray bar as set forth in claim 1, the spray request including a pulse per minute target value.

4. The spray bar as set forth in claim 1, each of the valve control modules including
drive circuitry for directing its corresponding valve drive element to open and close its corresponding valve in response to the spray request in accordance with precalibrated on and off duty cycles, and
a feedback circuit coupled between the valve drive element and the drive circuitry for monitoring operation of the valve drive element and for generating a corresponding feedback signal.

5. The spray bar as set forth in claim 4, the drive circuitry being operable for adjusting the pre-calibrated duty cycles in response to the feedback signal for adjusting the opening and closing of the valve.

6. The spray bar as set forth in claim 4, the pre-calibrated on and off duty cycles including a maximum duty cycle applied to the valve drive element to initially open the valve, a minimum duty cycle applied to the valve drive element after the valve has been opened, and an off duty cycle applied to the valve drive element when the valve is closed.

7. A spray bar dampening system comprising:
a spray bar including an
elongated support,
a plurality of spray nozzles spaced along the support,
a conduit carried by the support and connected to the nozzles for supplying fluid or other substance thereto,
a plurality of electrically actuated valves moveable between opened and closed positions to control the flow of fluid or other substance through the conduit to the nozzles,
a plurality of valve drive elements for driving the valves between the opened and closed positions,
a bar interface module positioned on the support and operable for receiving information from an external control element and for calculating a spray request signal in response to the information, the bar interface module including memory for storing a code representative of a logical address for the spray bar, and
a plurality of valve control modules positioned on the support, each coupled between the bar interface module and one of the valve drive elements, for controlling operation of the valve drive elements in response to the spray request from the bar interface module; and
a bar address module configured for mounting adjacent the spray bar and including structure for removably coupling with the spray bar, the bar address module including memory for storing a code representative of a physical location of the bar address module, wherein the bar interface module and bar address module communicate when the spray bar is coupled with the bar address module for permitting the bar interface module to determine the physical location of the spray bar based on the code in the memory of the bar address module.

8. A spray bar dampening system as set forth in claim 7, further including a network interface module for permitting external computing devices to communicate with the bar address module and spray bar, a remote terminal module including a display for displaying information relating to the operation of the spray bar, and a communication bus operably coupled between the bar address module and the network interface and remote terminal modules for providing communications therebetween.

9. The spray bar dampening system as set forth in claim 7, wherein the external control element is a speed measuring device for measuring speed of a printing press, the information being press speed.

10. The spray bar dampening system as set forth in claim 7, the spray request including a pulse per minute target value.

11. The spray bar dampening system as set forth in claim 7, each of the valve control modules including drive
circuitry for directing its corresponding valve drive element to open and close its corresponding valve in response to the fluid spray rate request in accordance with pre-calibrated on and off duty cycles, and
a feedback circuit coupled between the valve drive element and the drive circuitry for monitoring operation of the valve drive element and for generating a corresponding feedback signal.

12. The spray bar dampening system as set forth in claim 11, the drive circuitry being operable for adjusting the pre-calibrated duty cycles in response to the feedback signal for adjusting the opening and closing of the valve.

13. The spray bar dampening system as set forth in claim 11, the pre-calibrated on and off duty cycles including a maximum duty cycle applied to the valve drive element to initially open the valve, a minimum duty cycle applied to the valve drive element after the valve has been opened, and an off duty cycle applied to the valve drive element when the valve is closed.

14. A spray bar control system for attachment to a spray bar having a plurality of spray nozzles spaced along the length thereof, a conduit for supplying fluid or other substances to the spray nozzles, a plurality of electrically actuated valves operable to control the flow of fluid or other substances through the conduit to the nozzles, and a plurality of drive elements for driving the valves, the spray bar control system comprising:
a bar interface module positioned on the support and operable for receiving information from an external control element and for calculating a spray request signal in response to the information; and
a plurality of valve control modules positioned on the support, each coupled between the bar interface module and one of the valve drive elements, for controlling operation of the valve drive elements in response to the spray request from the bar interface module.

15. A spray bar control system as set forth in claim 14, the valve control modules further including:
drive circuitry for directing its corresponding valve drive element to open and close its corresponding the valve in response to the spray request in accordance with precalibrated on and off duty cycles; and
a feedback circuit coupled between the valve drive element and the drive circuitry for monitoring operation of the valve drive element and for generating a corresponding feedback signal.

16. The valve control modules as set forth in claim 15, the drive circuitry being operable for adjusting the pre-calibrated duty cycles in response to the feedback signal for adjusting the opening and closing of the valve.

17. The valve control modules as set forth in claim 16, the pre-calibrated on and off duty cycles including a maximum duty cycle applied to the valve drive element to initially open the valve, a minimum duty cycle applied to the valve drive element after the valve has been opened, and an off duty cycle applied to the valve drive element when the valve is closed.
